(19) United States
(12) Patent Application Publication
(10) Pub. No.: US 2006/0235997 A1
(43) Pub. Date: Oct. 19, 2006

(54) Methods And Sytems For Resolving Internet Protocol (IP) Address Conflicts Using Agents For A Zero Configuration Network

(75) Inventors: Vignesh Kumar Munirajan, Herndon, VA (US); Sandra E. Ring, Alexandria,, VA (US); Eric B. Cole, Leesburg,, VA (US)

Correspondence Address: MARTIN & HENSON, P.C., 9250 W 5TH AVENUE, SUITE 200, LAKEWOOD, CO, 80226, US

(73) Assignee: SYTEX, INC., Doylestown,, PA (US)

(21) Appl. No.: 10/907,836

(22) Filed: Apr. 18, 2005

(51) Int. Cl. G06F 15/16

(52) U.S. Cl. 709/245

(57) ABSTRACT

Systems and methods are provided for resolving Internet Protocol (IP) address conflicts using agents in the zero configuration network. Agent's originate at respective nodes on the zero configuration network. Each agent and each node logs a localized shared memory table (SMT) providing identifying information pertaining to other nodes on the network. When a sending node transmits an SMT to one or more target nodes on the network, it is analyzed by the target node to ascertain whether a localized IP address conflict exists involving the target node and a remote node. If it is deemed appropriate to resolve the conflict, the target node resolves the conflict by selecting a new IP address for itself.

### BACKGROUND OF THE INVENTION

1) Field of the Invention

The present invention relates to methods and systems for resolving Internet Protocol (IP) address conflicts in a zero configuration network, and more particularly to an agent-based approach for address allocation and conflict resolution which is derived from swarming intelligence teachings.

2) Discussion of Related Art

Today's computer networks are becoming increasingly dynamic in their configuration and less dependent on centralized services. Predominantly, these networks rely on common TCP/IP protocols such as DNS, DHCP, MADCAP and LDAP. These protocols generally require periodic administration which may not be feasible for a variety of reasons. Unfortunately, efficient configuration and management of networking communities has yet to emerge.

Administration currently relies on the availability and aptitude of individuals specifically responsible for a set community of nodes. For increasingly popular ad-hoc and small home networks, the technical knowledge of end-users is often limited and administrative skill can be lacking. In a world where networks are beginning to connect not only computer users of varying technical skills, but also a huge variety of personal digital devices, the end-user cannot always be expected to have the time, desire, or knowledge to configure the network. Thus, automatic network configuration has become an inevitable convenience, particularly on distributed networks.

Each device connected to an Ethernet network has two addresses—an Internet Protocol (IP) address and a Medium Access Control (MAC) address. Information is currently routed over the Internet by using a 4-byte IP address. However, packets are routed on each Ethernet segment by the hardware's MAC address, which is a 6-byte MAC address built into each network interface. Currently, there are three means by which hosts on a network are configured with unique IP addresses: 1) they are assigned static IP addresses that never change and have been de-conflicted across the entire network by a common administrator; 2) they are assigned unique dynamic IP addresses from a centralized address authority each time they connect to the network; or 3) they are capable of self-managing themselves by assigning and reconfiguring their own IP address as needed when conflicts occur. Self-management of networks is also referred to as zero configuration (or zeroconf) because no configuration to the host is necessary prior to its use on a network. This concept essentially expands the notion of plug-and-play used by many manufactures today to the network level.

The Internet Engineering Task Force (IETF) Zeroconf working group was established in 1999 and is responsible for standardizing methods of zero configuration networking that are efficient, inexpensive, and suitable for industry acceptance. The Zeroconf working group has explored automatic network configuration and issued various standards. Zeroconf is focused on developing protocols for 1) IP address configuration, 2) host name and IP address translation, and 3) service discovery on networks which have no centralized authority capable of managing this information. In zeroconf it is the network itself that is responsible for negotiating, maintaining, and exchanging information.

The traditional approach defined currently by the IETF for this management is through a series of probes and replies. There are several notable working implementations of this protocol. For example, at the 12^{th} International Conference on Information Networking in 1998, one concept for zero configuration was illustrated through an implementation of a Domain Name System (DNS) by C. Giap, Y. Kadobayashi, and S. Yamaguchi in “Zero Internet Administration Approach: the care of DNS”. Also known is Apple Computer's Rendezvous which is integrated into the MacOS X and uses standard link-local addressing.

Intelligence can manifest in many forms. Intelligence can exist in the judicious use of smartness (a collection of knowledge) of an entity or a group of entities. Animals, humans and robots can be analyzed as multi tasking autonomous control systems based on well-established ethological principles that exhibit intelligence. Biological systems are argued to exhibit a better understanding of intelligence than that of traditional ‘artificial intelligence’. Applications to biological based systems are constantly expanding.

One of the interesting aspects of biological-based studies is swarm intelligence. Swarm intelligence refers to the studies wherein intelligence is bestowed in a disembodied medium. Swarm Intelligence can be defined as the property by which a group of simple, autonomous (i.e., no central control involved), intelligent agents interacting indirectly and collectively bring about solutions to complex tasks. The tasks are usually distributive in nature. Basically swarms exhibit models of behavior-based systems which are autonomous and have a strong desire for reaction and adaptability. Robustness in problem solving is achieved with simple agents interacting in a dynamic environment to produce complex tasks. Examples of swarms include ant colonies, wasps, birds, cattle herds, frogs and other colony based living organisms. Some of the major works relating to ant colony optimization being employed in network architecture and control has been in the area of network routing, scheduling and resource discovery. The works conducted by Schoonderwoerd, Holland, Bruten and Rothkrantz for example, have addressed routing of telephone networks using ant based control algorithms.

Most often the algorithms used in control networks relate to ant communication and foraging. Foraging is an extensively studied topic in the area of swarm intelligence, and ant colony optimization directly maps to diverse applications compared to other aspects of the swarms. Ant foraging based models are very widely applied to many optimization problems such as the traveling salesman problem, the quadratic assignment problem etc., as well as clustering techniques including pattern recognition, image classification, etc. Apart from ant foraging, other colony level tasks such as division of labor based models and nest building based models have also been designed.

Foraging in ant colonies is achieved by physical communicational attributes of the ants called pheromones. The pheromones are natural secretions from the ant over the trail that it would follow in the act of performing a task, such as foraging or scouting. Ants are entities which exhibit action-reaction mechanisms. The action-reaction mechanisms form a chain of events that build up collaterally and adaptively to realize the goal at the global level. For example, in the case of ant navigation, the act of an individual ant depositing a pheromone at a point that it visits would form an action on its part, the reaction to which would be reflected in any other ant(s) following up previously established pheromone tracks.

The current approach to network administration, which relies on the availability and knowledge of individuals that are dedicated to maintaining them, can be inefficient and the quality of service varies greatly depending on the capabilities of those monitoring the network. As networks grow, and their complexity increases, this pool of administration talent must too grow to meet this need. A need, thus, remains for a better alternative which is not prone to the inherent limitations attendant with current network administration. Zero configuration networking endeavors to do just that by directly building mundane and repetitive tasks of administration directly into software itself, and it is believed that a swarm intelligence-based approach to zero configuration will provide a versatile way, for example, to automatically select and configure IP addresses without requiring centralized management of the addressing scheme.

### BRIEF SUMMARY OF THE INVENTION

In its various forms the present invention provides methods and systems for resolving Internet Protocol (IP) address conflicts for a zero configuration network. According to a broad implementation of the methodology, a plurality of agents are provided each originating from a respective origin node (e.g. a personal computer system) that is characterized by a node address. Each agent and each node includes a localized shared memory table (SMT) which logs known identifying information pertaining to other nodes on the network. A first agent's SMT is transmitted along the zero configuration network to a target node which detects the SMT and analyzes the identifying information to determine whether an IP address conflict exists involving the target node and another remote node (sometimes referred to as the “conflicting node”). If the conflict adheres to selected conflict criteria, then it is resolved by the target node. To reduce system overload during actual implementation, it is preferred to only resolve address conflicts which arise between the target node and the first agent's node of origin.

In any event, upon ascertaining that a conflict exists, the target node resolves the conflict by reconfiguring it's IP address, preferably by selecting one which is currently unused in its associated SMT. Advantageously also, this can be accomplished through a random address selection. The origin node may then be informed of the address change, such as by the target node transmitting its revised SMT (now containing the new IP address), to the target node.

In exemplary embodiments of the invention, each SMT is organized as a plurality of record entries. Each entry is associated with a respective node on the network and has an associated timestamp indicating when the record entry was logged. Each record preferably includes an IP address for the respective node and a unique identifier, such as a Medium Access Control (MAC) address, for the respective node. Also in preferred embodiments of the invention, the target node ascertains a need to resolve an IP address conflict when a comparison of it's MAC address to the MAC address for the node of origin satisfies a selected comparison criteria.

One embodiment of a system broadly comprises an origin node which transmits a first agent's SMT along the network, and a target node which receives the SMT and determines if an address conflict exists between the target and origin nodes. Advantageously also, the target node can compare each entry within the first agent's SMT to each entry within its own SMT to ascertain whether another node has reconfigured it's IP address, whether an address conflict exists with respect to any two nodes on the network, or whether the respective entry within the first agent's SMT is known to the target agent. If another agent has reconfigured its IP address, the target node updates it's SMT with the respective entry within the first agent's SMT. If an address conflict exists, the target node may resolve the conflict if it is localized. If the respective entry is unknown to the target node it is added to it's SMT. However, if the entry is known, the target node maintains in its table the version with the more recent timestamp.

Another embodiment of a system includes a plurality of agents, a transmission component associated with each node for selectively transmitting each agent's SMT to other remote nodes on the network, and a detection component associated with each node for receiving each agent's SMT. The detection component analyzes the identifying information in the received SMT to ascertain existence of, and resolve, an IP address conflict with any remote node on the network which satisfies the conflict criteria.

These and other objects of the present invention will become more readily appreciated and understood from a consideration of the following detailed description of the exemplary embodiments of the present invention when taken together with the accompanying drawings, in which:

### BRIEF DESCRIPTION OF THE DRAWINGS

FIG. 1 is a block diagram showing a representative configuration of a zero configuration network in accordance with the present invention;

FIG. 2 illustrates a diagram of a representative general purpose computer system that may be configured to accommodate one or more agents and nodes for implementing aspects of the present invention;

FIG. 3 is a block diagram of a representative network communications device which supports a plurality of nodes with at least one agent for per node;

FIG. 4 diagrammatically illustrates the logical construct for the shared memory table (SMT) associated with each agent and each node;

FIG. 5 is a high level flow diagram for representing the global functionality for each node;

FIG. 6 is a flow diagram illustrating an exemplary embodiment of a method for resolving IP address conflicts in accordance with the invention;

FIGS. 7a-7h, collectively comprise the flow of programming code for computer software which implements each node's functionality;

FIG. 8 is a diagrammatic view of an encapsulated zero configuration packet construct in accordance with the invention; and

FIG. 9 shows simulation results obtained for network convergence involving four nodes, three of which are initially configured on a zero configuration network, and one of which thereafter joins the network.

### DETAILED DESCRIPTION OF THE INVENTION

In the following detailed description, reference is made to the accompanying drawings which form a part hereof, and in which is shown by way of illustrations specific embodiments for practicing the invention. The leading digit(s) of the reference numbers in the figures usually correlate to the figure number; one notable exception is that identical components which appear in multiple figures may be identified by the same reference numbers. The embodiments illustrated by the figures are described in sufficient detail to enable those skilled in the art to practice the invention, and it is to be understood that other embodiments may be utilized and changes may be made without departing from the spirit and scope of the present invention. The following detailed description is, therefore, not to be taken in a limiting sense, and the scope of the present invention is defined by the appended claims.

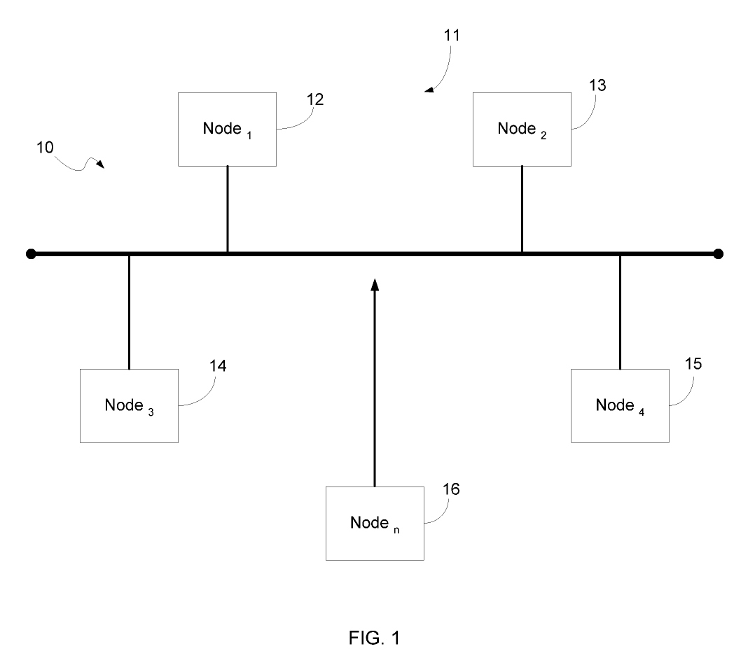

In it's various forms, the present invention provides systems and methods for resolving Internet Protocol (IP) address conflicts in a zero-configuration network. For illustrative purposes, a block diagram of a representative zero configuration network 10 is shown in FIG. 1. Network 10 includes a plurality of nodes, generally 11, some of which are already joined to the network 10 and configured to communicate with one another. More particularly, nodes 12-15 are joined to the network, while another node 16 is about to connect to the network 10 and be configured with it's node IP address.

In practice, network 10 can assume a variety of configurations. For example, network 10 can be a wired Ethernet segment, such as a local area network (LAN). Alternatively, network 10 can be a wireless network. In preferred embodiments of the invention, each node adheres to IPV4, but it is contemplated that the concepts of the present invention can readily be applied to other Internet Protocol versions, such as IPV6, and indeed perhaps other addressing schemes which do not require IP.

The present invention finds particular use in situations where decentralization and autonomy is desired, as opposed to other types of addressing schemes such as those which require use of a DHCP server for address allocation. A de-centralized construct might be desirable in a variety of circumstances, such as when emergency response teams need to quickly and efficiently join a common network—for example, a cell phone network—on short notice and coordinate their efforts. Another situation might arise when individuals who are not normally joined on a common network wish to communicate for a limited purpose, such as a web conference or the like. In any event, the ordinarily skilled artisan will realize that the addressing scheme of the present invention can be employed in a variety of applications and on a variety of network configurations either separate from, or in conjunction with, other more centralized addressing approaches.

Advantageously, the de-centralized addressing scheme of the invention allows for participants on the zero configuration network to easily and efficient become authorized on the network. To this end each participant is more broadly considered a node on the network, such that each node contemplates some type of addressable network communications device. Each node may, thus, be supported by a workstation, a desktop computer system, a laptop, a printer or any other suitable device, without limitation.

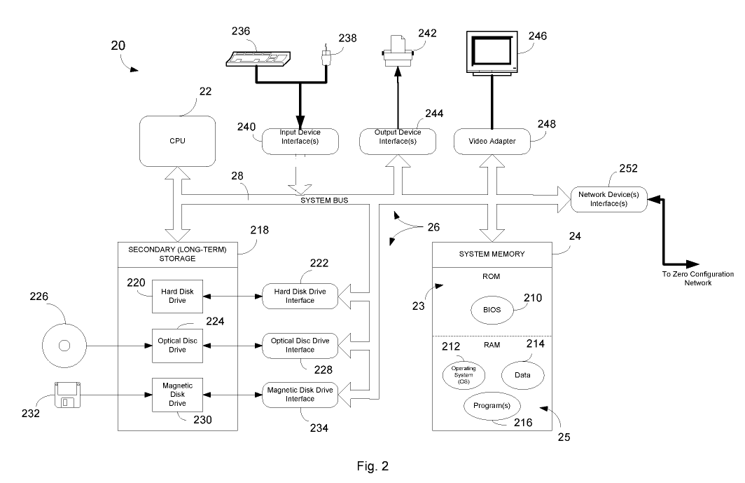

FIG. 2 shows a representative configuration of a computer for implementing aspects of the invention. Computer 20 is configured as a general purpose computer system, and the artisan should recognize that not all of the components which are depicted in FIG. 2 need be present to realize the capabilities afforded by the present invention. Thus, FIG. 2 is for representative purposes only.

With this in mind, computer system 20 includes a processing unit, such as CPU 22, a system memory 24 and an input output (I/O) system, generally 26. These various components are interconnected by system bus 28 which may be any of a variety of bus architectures. System memory 24 may include both non-volatile read only memory (ROM) 23 and volatile memory such as static or dynamic random access memory (RAM) 25. Programmable read only memories (PROMs), erasable programmable read only memories (EPROMs) or electronically erasable programmable read only memories (EEPROMs) may be provided. ROM portion 23 stores a basic input/output system (BIOS) 210. RAM portion 25 can store the operating system 212, data 214, and/or programs 216 such as the agent server program described herein. Computer system 20 may be adapted to execute in any of the well-known operating system environments, such as Windows, UNIX, MAC-OS, OS2, PC-DOS, DOS, etc.

Various types of storage devices can be provided as more permanent data storage areas which can be either read from or written to, such as contemplated by secondary storage region 218. Such devices may, for example, include a permanent storage device in the form of a large-capacity hard disk drive 220 which is connected to the system bus 28 by a hard disk drive interface 222. An optical disk drive 224 for use with a removable optical disk 226 such as a CD-ROM, DVD-ROM or other optical media, may also be provided and interfaced to system bus 28 by an associated optical disk drive interface 228. Computer system 20 may also have one or more magnetic disk drives 230 for receiving removable storage such as a floppy disk or other magnetic media 232 which itself is connected to system bus 28 via magnetic disk drive interface 234. Remote storage over a network is also contemplated.

System 20 is adapted to communicate with a the zero configuration network (e.g., LAN, WAN, the Internet, etc.) via communication link(s). Establishing the network communication is aided by one or more network device(s) interface(s) 252, such as a network interface card (NIC), a modem or the like which is suitably adapted for connection to the system bus 28. System 20 preferably also operates with various input and output devices. For example, user commands or other input data may be provided by a keyboard 236, a mouse 238 or other appropriate device which is connected to the processing unit 22 through an appropriate interface(s) 240 connected to system bus 28. System 20 is also adapted to receive one or more output devices, such as printer 242, coupled to the computer system bus 28 via an appropriate output device interface(s) 244. A monitor 246 or other suitable display device may also be connected to the system bus 28, for example, by a video adapter 248. A variety of input, output and display devices are available and any suitable one(s) which may be used or needed for effectuating the purposes of the invention are deemed to be encompassed.

One or more of the memory or storage regions mentioned above may comprise suitable media for storing programming code, data structures, computer-readable instructions or other data types for the computer system 20. Such information is then executable by processor 22 so that the computer system 20 can be configured to embody aspects of the present invention. Alternatively, the software may be distributed over an appropriate communications interface so that it can be installed on the user's computer system.

Although certain aspects of a computer system may be preferred in the illustrative embodiments, the present invention should not be unduly limited as to the type of computer on which it runs, and it should be readily understood that the present invention indeed contemplates use in conjunction with any appropriate information processing device having the capability of being configured in a manner for accommodating the invention. Moreover, it should be recognized that the invention could be adapted for use on computers other than general purpose computers, as well as on general purpose computers without conventional operating systems.

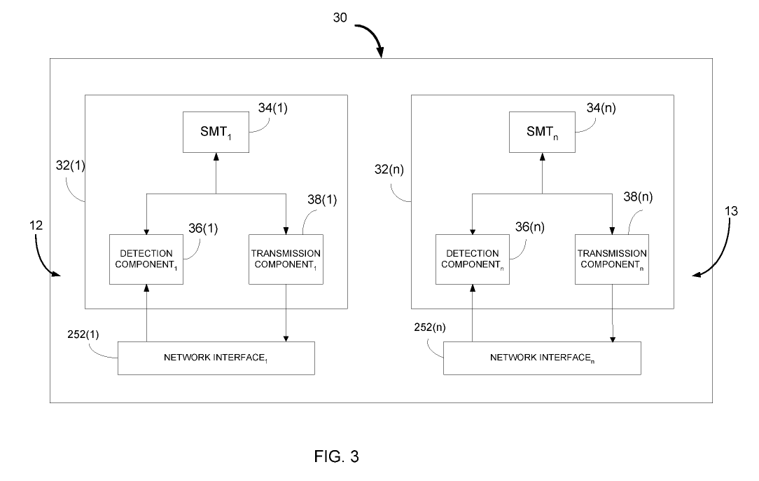

The various nodes have certain characteristics in common, such as diagrammatically illustrated by network communications device 30 in FIG. 3 which supports a plurality of nodes, such as nodes 12 & 13 from FIG. 1. Each node on device 30 includes a respective network interface 252(1)-252(n) such that there is a one-to-one correspondence between the number of network interfaces and the number of nodes. Respectively for each node 12 & 13 is at least one associated agent 32(1)-32(n) which is original to it.

The functionality of each node may be realized by a server program residing in user space on the node. Alternatively, although not necessarily preferred, the functionalities of each node could be accomplished through modifications to the kernel for the network communications device 30. Each node is separately addressable and has it's own unique identifier. Each node and each agent has a localized shared memory table (SMT) 34(1)-34(n), respectively. A localized SMT is stored on each node and each agent travels along the network with its own SMT that is originally created at the agent's node of origin and updated as the agent (i.e. a zero config. packet containing an SMT) travels along the network infrastructure to other nodes where information is exchanged. There can be multiple like agents original to each node. While these agents would initially be identical to one another (i.e. their respective SMTs would initially be the same) there characteristics will deviate from one another as the each traverse the network and encounter other nodes.

Each SMT 34(1)-34(n) contains a log of identifying information for other known nodes on the network (referred to as remote nodes), as well as identifying information for the SMT's origin node. Each node also includes an respective detection component 36(1)-36(n) for receiving SMTs carried by agents (each referred to as a received SMT). Each node also includes a transmission component 38(1)-38(n), respectively, for sending each agent's SMT within a zero configuration data packet to one or more other remote target nodes on the network.

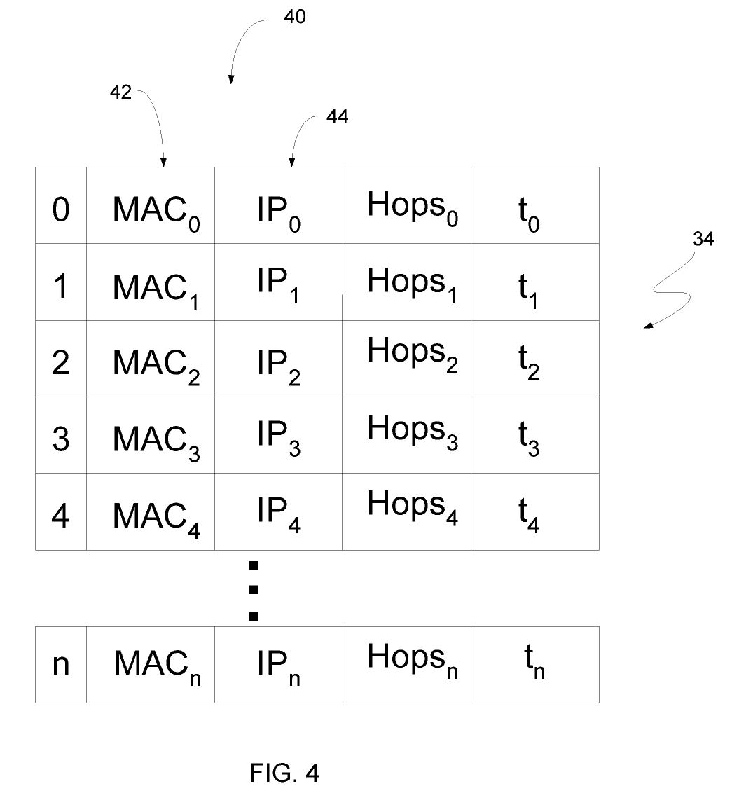

FIG. 4 shows a logical construct 40 for the SMT 34 associated with each agent and each node. SMT 34 includes a plurality of record entries, each characterized by an associated indexing number 0-n, respectively, and an associated timestamp t₁-tₙ, respectively. Record entry 0 is preferably reserved to identify the node of origin where the SMT 34 was originally created, while record entries 1-n respectively identify each remote node on the network as it becomes known. Each timestamp t₁-tₙ might identify the local node time at which the particular record entry was created, or the time at which the entry was created on a remote node if that information has been copied. Each entry may also have an associated hop count, as shown, which indicates the number of nodes visited by the agent transporting the SMT. This information can be collected for statistical analysis, or for use in making the process more efficient.

The identifying information, generally 40, within each SMT 34 preferably includes a unique identifier 42 and an allocated address 44 for each node. The unique identifier 42 is preferably the MAC address for the associated node's network interface, or it may be some other type of unique identifier which has been assigned to the node and uniquely distinguishes it from other nodes on the network. Thus, while a MAC address is quite suitable for this purpose, the artisan will recognize that other designations could be employed. It is contemplated that each particular designation may or may not be generated through the program itself, or may even be truncated version or derivation of the MAC address. A similar understanding entails for the node's network address, although it is preferred that each address conform to the well known IPV4 standard.

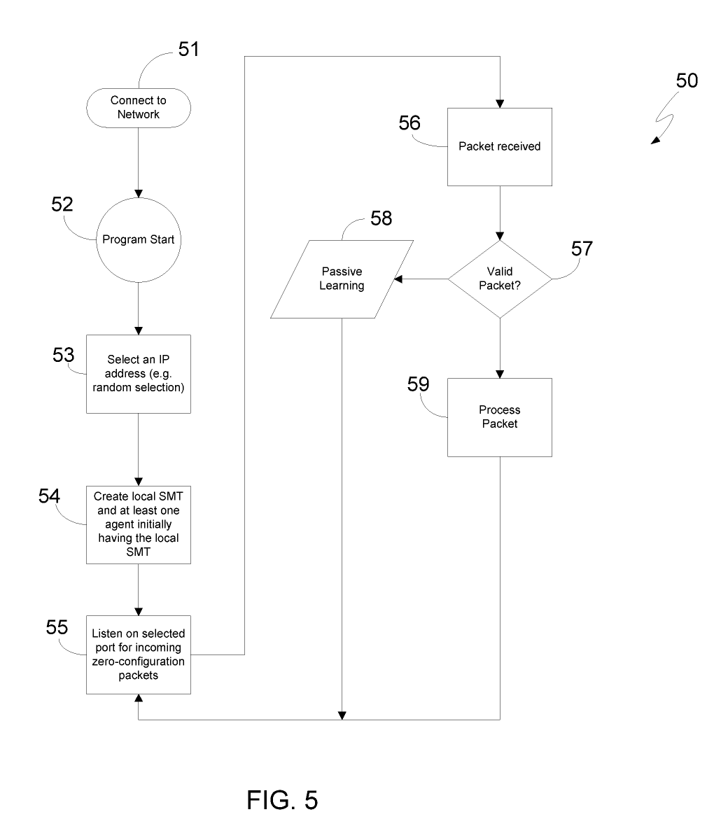

FIG. 5 depicts a high level flow diagram 50 to illustrate what occurs when a given node initially joins the zero configuration network, such as node 16 in FIG. 1. Initially, at 51, the node accesses the network. In the case of a wired network this might contemplate a user plugging in the Ethernet cable to the Ethernet port on the computer system. Alternatively, if the system is already plugged in but shut down, step 51 might contemplate the user simply turning on the computer system to activate the agent server. Once access is established, the node's program starts up at 52 and initially selects an IP address for the node at 53. This initial IP address is logged, along with the node's MAC address, as the first entry within an SMT table, and a local timestamp is stored for the entry. At least one agent is created having the SMT. Preferably, a plurality of like agents are initially created which are original to the node.

Then, at 55, the node listens for incoming packets from other nodes, wherein each packet includes the SMT for a particular traveling agent. The local node listens on a particular port, preferably one which is not used for conventional network communications. For each packet received at 56 a verification is made at 57 as to whether it is a valid packet. This can be accomplished in a variety of ways such as with a type-of-service field, checksum, or other suitable mechanism. If the packet is deemed invalid, such as in the case of a compromise to the network, then the packet can still be analyzed passively at 58 in an effort to learn information about the unauthorized access. Otherwise, each packet is processed at 59 so that the localized SMT of the node can be modified as needed.

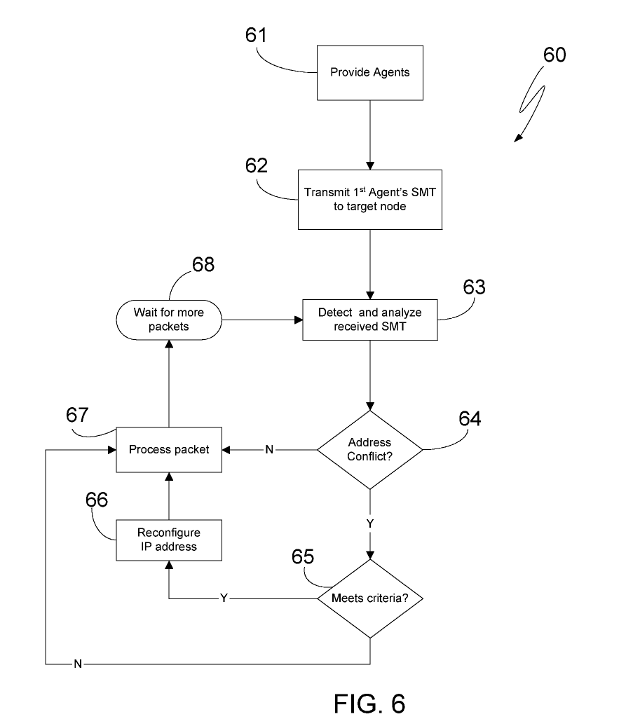

A somewhat different implementation of a methodology 60 according to the invention is shown in FIG. 6. At 61 a plurality of agents are provided each originating from a respective node that is characterized by a node IP address. At 62 a first agent's SMT is transmitted along the network to a target node. This is detected and analyzed at 63 to ascertain at 64 whether an address conflict exists involving the target node and another remote node (i.e. a conflicting node). If so, and if the conflict satisfies selected criteria at 65, it is resolved by the target node at 66 through reconfiguration of the target node's IP address. The target node can continue processing the packet at 67 (if desired) to effectuate any additional changes to its local SMT. Additional processing preferably also takes place even if there is no conflict. Once any additional processing is completed, the agent enters a waiting mode at 68 for receipt of any further packets.

Swarming intelligence concepts are used, particularly the notion of ant colonies, in implementing the zero configuration network. The agents (i.e. the packets containing the SMTs) are akin to ants in swarming intelligence technologies, and each node is somewhat akin to an ant hill in that it is a place where information may be exchanged or purged. Agents originate at each node and are transmitted to other nodes for the purpose of exchanging information with them. One benefit of this approach is that each agent is capable of traveling with learned information which increases the speed of convergence when compared to traditional link-local addressing. The concept of convergence entails the mutual recognition of each node on the zero configuration network, and the selection of a unique IP address for each node.

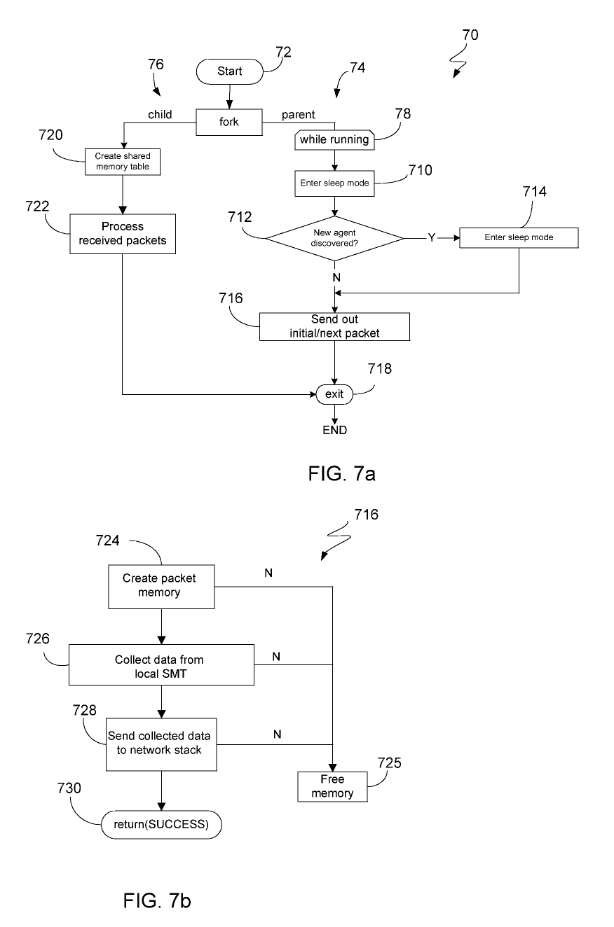

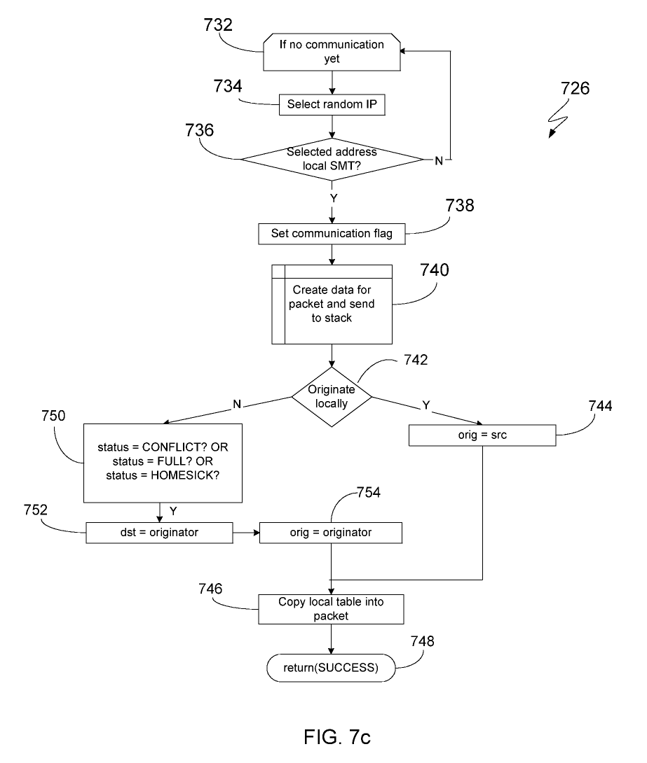

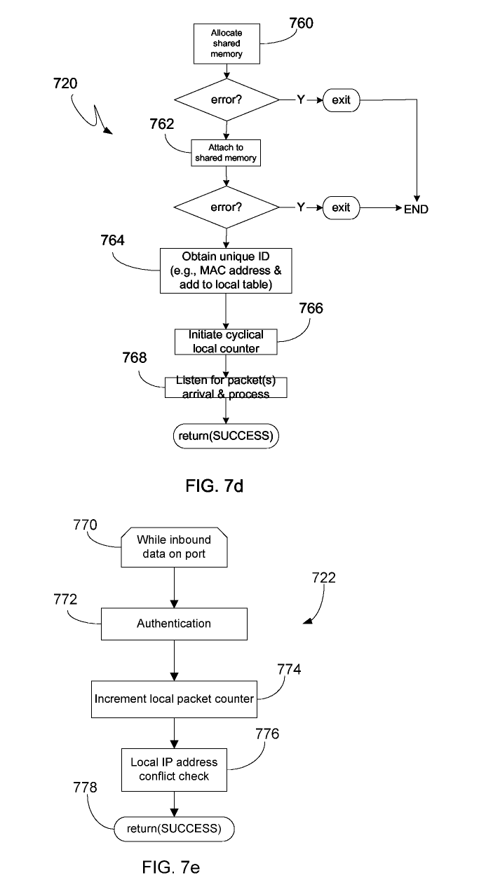

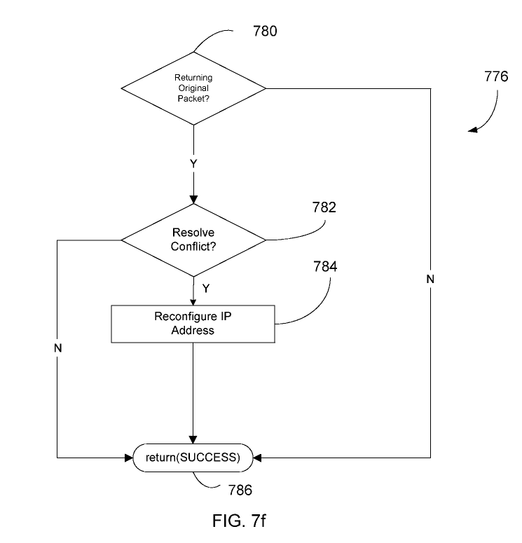

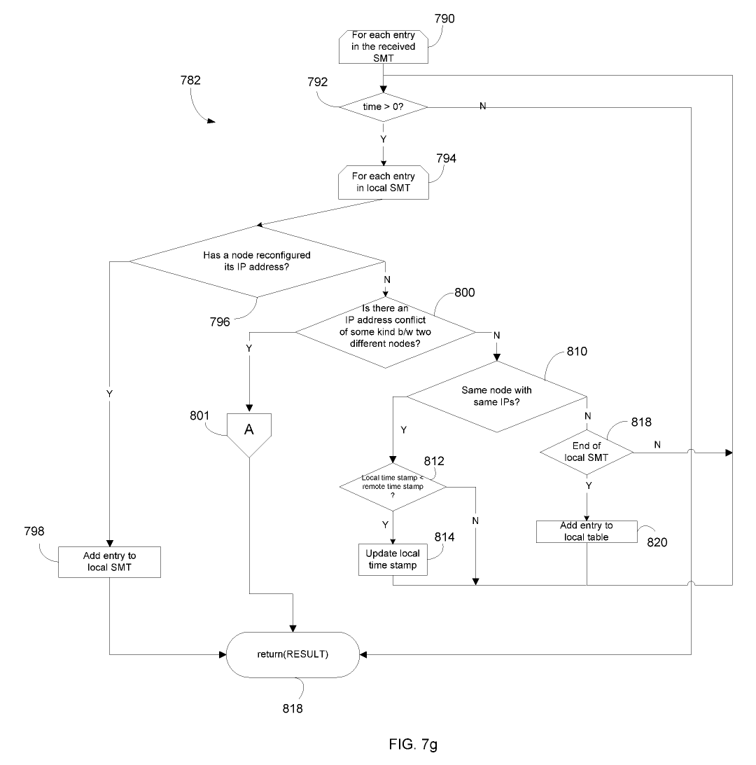

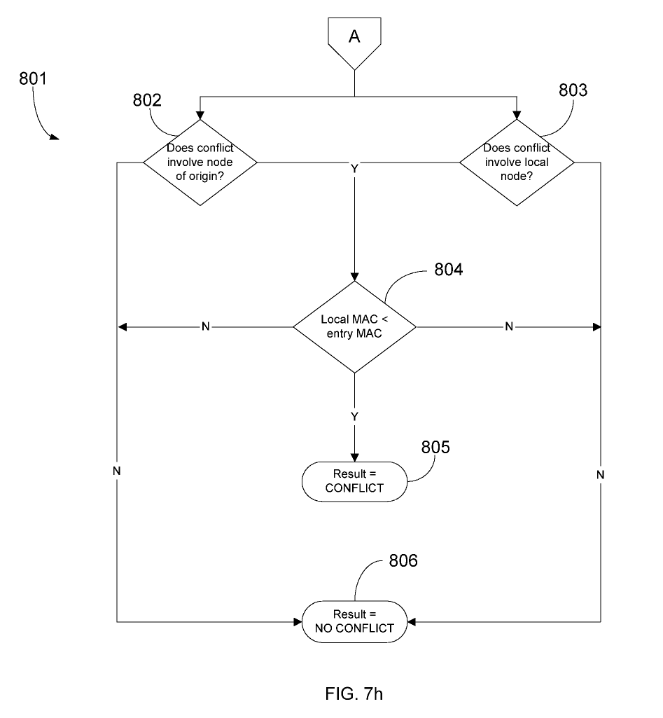

The program flow diagrams of FIGS. 7a-7h collectively illustrate what may take place at each node on the zero configuration network. Simulations have been performed in accordance with these flow diagrams to observe system responses for various parameters and setups. The simulations were performed with four nodes (one agent per node) running Red Hat Linux with standard TCP/IP ports. In the simulation, setup runs were made for three nodes initially configuring themselves and a fourth node being subsequently brought onto the network. Each node's timestamp counter was made to increment cyclically during the simulations. Convergence occurred upon the mutual recognition of each of the nodes and their respective selection of a unique IP address on the network.

The source code for each node's server program was developed in the C programming language using a standard compiler. The software, however, could be readily ported to other types of Unix platforms such as Solaris®, BSD and the like, as well as non-Unix platforms such as Windows® or MS-DOS®. Further, the programming could be developed using several widely available programming languages with the software component(s) coded as subroutines, sub-systems, or objects depending on the language chosen. In addition, various low-level languages or assembly languages could be used to provide the syntax for organizing the programming instructions so that they are executable in accordance with the description to follow. Thus, the preferred development tools utilized by the inventors should not be interpreted to limit the environment of the present invention.

With initial reference to FIG. 7a, each node's program starts at 72 and initially forks into parent and child processing branches 74 and 76, respectively. As for the parent processing branch 74, while the program is running 78 the node initially enters into a sleep mode at 710 where it preferably waits for a random period of time before initiating any outbound packet activity. This is a safeguard to prevent flooding of the network in the event that numerous nodes connect and send out agents at the same time. A determination is then made at 712 as to whether another remote node was discovered while the local node was in sleep mode. That is, it is possible that one or more packets were received during sleep mode and that identifying information was entered into the node's local SMT table. If this is the case, then the local node enters another sleep mode at 714 before sending out its first packet at 716. Otherwise, the node proceeds directly to packet transmission 716 after initial sleep mode 710. The parent process will periodically transmit packets (each containing an agent's SMT) at 716 while the program is running before eventually exiting at 718. The child processing thread 76 initially creates the node's local SMT at 720, after which it processes any received packets at 722 and updates the local SMT as needed.

Reference is now made to FIGS. 7b & 7c to describe the packet transmission step 716 of FIG. 7a. With initial reference to FIG. 7b, memory (preferably ROM) for the packet is established at 724 and an agent's local SMT data is collected at 726. The packet is then sent to the normal network stack 728 which configures the data into a zero configuration packet according to known protocols. Sending of the packet can be accomplished, in the Unix OS for example, by utilizing the setsockopt( ) and sendto(packet) functions.

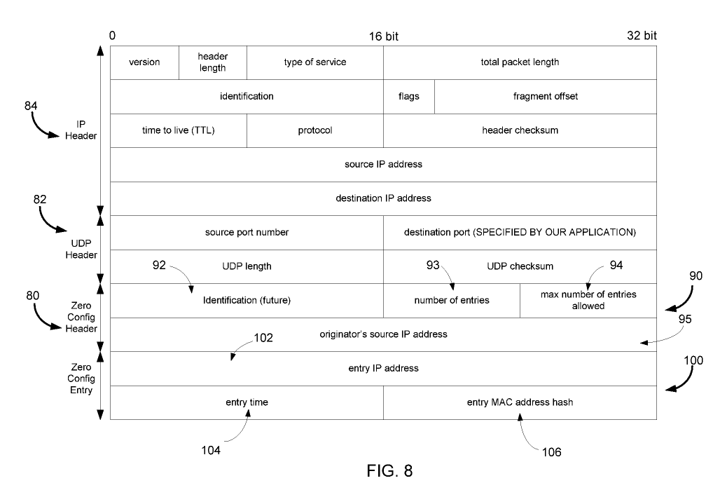

The zero configuration packet preferably has the structure 80 as shown in FIG. 8 when it is transmitted along the network via the local agent's network interface. Presuming each of the above sub-routines occurs without an error, a success flag is returned at 730. Otherwise, the memory at 724 is freed at 725 as a precautionary safeguard so that the system does not become overloaded.

FIG. 7c illustrates the sub-routine 728 for establishing the zero configuration packet's data. If there has yet to be a communication between the local node and any remote node at 732, the local node selects a random IP address at 734 and ascertains at 736 whether the selected address is within its local SMT table. Initially the address should not be in the table so the node proceeds with the remainder of sub-routine 728. However, sub-routine 728 can also be called from the child process 76 in FIG. 7a if the node reconfigures its IP address and transmits the same in a revised local SMT to other nodes, or if it forwards a packet from another node. Accordingly, it is possible that the response to inquiry 736 may be in the affirmative, thus, requiring the node to select another IP address at 734. In any event, once a new IP address is selected which is not in the local SMT table, a flag is set at 738 to indicate that the node will now be communicating. Data is collected for the zero configuration packet at 740 from the local SMT table which was created via the child-processing branch.

The zero configuration packet structure 80 in FIG. 8 preferably forms the payload of a UDP packet having a header structure 82 and, together, they form the payload for an IPv4 datagram having an associated header 84, all as known in the art. Packet 80 includes a header portion 90 and a data entry portion 100. Identification field 92 can be reserved to distinguish between versions of the zero configuration packet 80, as desired. Field 93 indicates the total number of record entries passed within the packet from the local SMT table, such as entries 1-n in FIG. 4. Field 94 of the header 90 indicates the number of hops allowed/remaining for the particular packet, such as also indicated by the hops column in FIG. 4.

The source IP address for the originator of the packet (i.e. the origin node) is included in header field 95. Thus, for example, during the initial pass through sub-routine 728 in FIG. 7c, field 95 would indicate the local node as the packet's origin. However, packet data for other transmissions may actually originate from remote node(s) and be forwarded by the local node. In such situations, the respective remote node will be identified in field 95 as the originator. The remainder of the data pertaining to the various record entries within the particular SMT being transmitted is populated into fields 102, 104 and 106.

If it is determined at 742 in FIG. 7c that the subject packet to be transmitted is originating with (or originated from) the local node, then at 744 the source and originator of the packet are assigned the same value (i.e. the local agent's IP address) which will populate the header field 95 of FIG. 8 when the packet is processed by the stack. The node's local SMT is then copied at 746 in order to populate the various fields 102, 104 and 106 in FIG. 8 accordingly. A success flag is then returned at 748 to process 714 in FIG. 7b.

If, however, a packet is to be transmitted corresponding to an SMT table which did not originate from the local node, then the flow proceeds at 750 in FIG. 7c. Status “conflict” indicates that there is a conflict to be resolved (described below) between the local node and some remote node. Status “homesick” indicates whether the system is configured to immediately return the packet to its originator, and status “full” indicates that the agent traveled from node to node gathering address information and that its SMT is now full. These flags can be selectively used in configuring the system to return each packet to its originator and/or forward the packet to one or more other remote node, or do other actions with respect to the packet. The simulations themselves were configured to return each packet to its originator. In doing so, then, the destination and origin fields for the packet are assigned at 752 and 754, respectively, after which flow proceeds to step 746 and returns a success flag at 748.

With reference again to child process 76, an understanding of it may be better appreciated with reference to FIGS. 7d-7h which, collectively, illustrate the flow for creation of the shared memory table 720 and the processing of received packets 722. Creation of the shared memory 720 comprises the allocation of memory space at 760 in FIG. 7d and attaching to the allocated memory at 762. Assuming this proceeds without error, the unique ID for the respective node is obtained at 764 and, again, this is preferably done by making use of the MAC address for the node's associated network interface. A cyclical local counter is initiated at 766. In practice, this counter can continuously loop in, for example, every 1,000 or 3,000 seconds increments, or other suitable period of time based on the application. Generally speaking the rate of convergence will decrease as the counter frequency and count limit increase. At this point 768, child process 76 listens for incoming packets and processes them accordingly.

In FIG. 7e packet processing 722 begins by detecting incoming zero configuration packet data on the designated port at 770 and, preferably, authenticating the traffic at 722 to ensure that it has not been compromised. Again, authentication can occur in a variety of ways that would be well apparent to the skilled artisan. A local packet counter can be incremented at 774 to keep track of the occurrence of inbound traffic to the local agent. In the simulations which have been conducted, the packet counter was used for statistical analysis, for example, to determine the rate of convergence on the zero configuration network. At this point 776, the local node analyzes the inbound packet's received SMT to ascertain existence of a local IP address conflict in need of resolution, after which the sub-routine returns at 778.

Conflict check 776 begins at 780 in FIG. 7f by ascertaining whether the inbound packet having the received SMT is a return packet which originated at the local node. If so, and if a resolvable conflict is deemed to exist at 782, then the local node reconfigures its IP address at 784.

In the situation where there is a conflict which does not satisfy the conflict criteria, then the local node can either return the received packet to it's originator or forward it to another randomly selected remote node on the network. It is preferred to return the packet directly to the originator only in the situation where there is a conflict with an originator, but the conflict is not of the type which requires the local node to change its IP address. Thus, and as will be appreciated with reference to the description of FIGS. 7g & h, when the originator gets the return packet it would ascertain not only existence of a conflict, but one which needs to be resolved by it, in which case the originator would ultimately resolve the conflict by reconfiguring its IP address.

The particular procedure 782 for ascertaining a resolvable conflict with respect to each received SMT is now described with reference to FIGS. 7g & h. Each entry in the received SMT at 790, which has a timestamp greater than 0 (i.e. it is not a blank entry) as determined at 792, is compared to each entry in the local SMT 794. One or more determinations are preferably made with respect to each comparison of the entries. At 796 an initial determination is made as to whether a node identified by the agent's respective entry in the received SMT has reconfigured it's IP address. This determination is more particularly accomplished by comparing the MAC addresses, the IP addresses and the timestamps associated with the two entries being compared. For example, if the entry within the received SMT has the same MAC address as the associated entry within the local SMT, but a different IP address and a more recent timestamp, then the associated node in the received SMT table has reconfigured it's IP address and the subject entry is added to the local SMT at 798 to bring it current.

If there has not been an address reconfiguration, flow proceeds to inquiry 800 to ascertain if there is some type address conflict between the compared entries. This would occur if the MAC addresses are different but the IP addresses are the same. In the case of an address conflict, its type is then ascertained at 801 (FIG. 7h).

It is preferred that each agent and each node have self-identifying information logged as the initial entry (i.e. entry “0” in FIG. 4) in its associated SMT. As mentioned above, is also preferred that conflicts only be resolved in the situation where the conflict arises between the local node (i.e. the target node for the packet) and the remote node of origin which initially created the received SMT being parsed. This determination can be made by ascertaining at 802 whether the conflict involves the node of origin, and at 803 whether it involves the local node. More particularly, it is initially determined whether the two entries in conflict are the initial entries in both the received SMT and the target node's SMT. If these two nodes are involved, then the MAC addresses for the respective entries are compared at 804. If this comparison satisfies a selected comparison criteria, such as the local/target node's MAC ID being less than that of the origin node's SMT, then a conflict result is established at 805 to identify that there is a conflict which needs to be resolved. This status is then returned as the result 818 (FIG. 7g). Otherwise, a “no conflict” result 806 is returned.

It can be appreciated from the flow diagrams of FIGS. 7g & h that, unless the conflict is one which is deemed to be in need of resolution, the local/target node's IP address is not reconfigured. The artisan will appreciate, though, that this is a design preference relating to a preferred implementation but is not a requirement. That is, other types of systems could be designed to send suitable notifications along the network or make other attempts to resolve the encountered conflict, as desired.

Once a conflict in need of resolution is ascertained, the IP address of the local node is reconfigured at 784 in FIG. 7f. This may be accomplished in a variety of ways. One approach is to randomly select a new IP address for the local node which is not within its SMT. Other approaches could select the new IP address either semi-randomly or intuitively based on authorized address ranges for nodes on the network, a historical account of addresses which have been used, etc.

With reference again to FIG. 7g, if there is no address conflict of any kind at 800, then flow proceeds to 810 to ascertain if the entries being compared relate to the same node (i.e. equal MACs) being identified by the same IPs. If this is the case, but the associated timestamp in the received table's SMT is more recent at 812, then the local SMT's entry is updated with the more current timestamp at 814. If, on the other hand, the response to inquiry 810 is in the negative, then flow proceeds at 818 to determine if a pointer is at the end of the local node's SMT. If so, then the received SMT's entry is unknown to the local node, and added to its SMT at 820 before proceeding further through the remainder of the entries, if any.

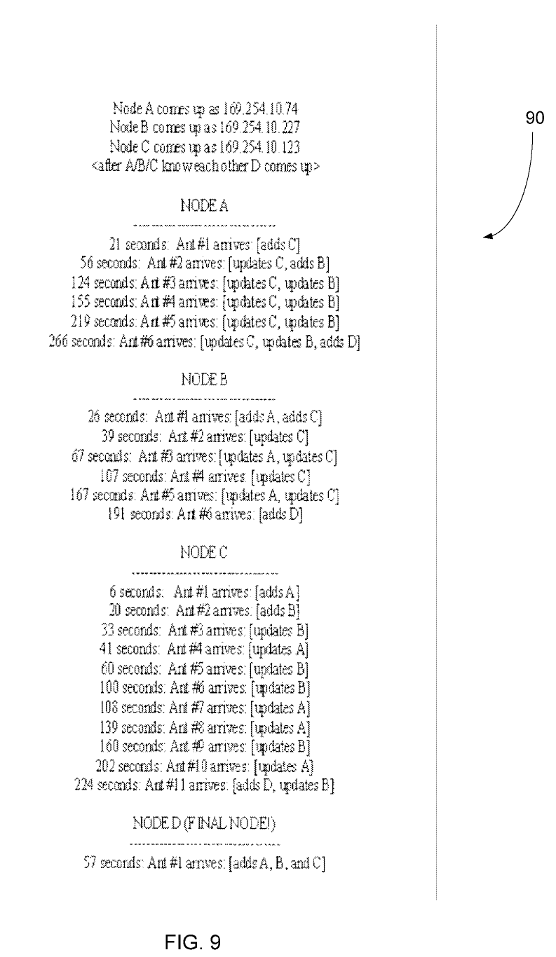

Finally, FIG. 9 shows output results 90 which were generated during a representative simulation in which nodes A, B and C initially configured themselves, after which a fourth node D was brought into the network. The timestamp counter at each node A-D was made to tick every second during the simulation. From the results of FIG. 9 it can be seen that it took no longer than 300 seconds for convergence to occur.

The robustness and versatility of the present invention can be appreciated when many nodes come into the system progressively to get zero-configured. The nodes that come in when most of the nodes have already stabilized would experience relatively little time in becoming configured on to the network. Moreover, the implementation of the present invention can also be analyzed with wireless set ups which are incidentally more prone to network failures. It is believed that wireless nodes will become primary in demanding zero-configuration at airports, with emergency response units, etc.

One aspect which might require some additional attention would be the arrival of DHCP servers on the network. This would likely necessitate a modified configuration procedure controlled by these servers. The issue would be ascertaining DHCP services and making the network configured with DHCP. Since the DHCP servers will not appoint any address in the 169.254/24 range (which is exclusively provided for Zero-Configuration Purposes), they can be identified from anywhere within the network. DHCP information can be propagated using the same packets used for zero-configuration, in which case each agent would could receive the new DHCP information through an IP alias interface (eth0:1) until all pending transfers on the primary interface eth0 is completed. This ensures that ongoing transactions are not disrupted when centralized configuration services are brought in.

Simulation results support that optimization through swarming intelligence concepts can be highly beneficial in network management and control. Known approaches for achieving zero-configuration do not provide for distributed intelligence theories to be incorporated and, thus, can become very feasible with large networks. For instance, warfront and space exploration activities typically involve the incoming of a large number of nodes for network set ups. Such large networks in unconventional environments would require highly distributed services for functionality and operations. Swarm intelligence, however, lends itself nicely to a variety of applications, particularly ones of this nature.

Accordingly, the present invention has been described with some degree of particularity directed to the exemplary embodiments of the present invention. It should be appreciated, though, that the present invention is defined by the following claims construed in light of the prior art so that modifications or changes may be made to the exemplary embodiments of the present invention without departing from the inventive concepts contained herein.

What is claimed is:

1. An agent-based method for resolving Internet Protocol (IP) address conflicts for a zero configuration network, comprising:
a. providing a plurality of agents each originating from a respective origin node that is characterized by a node address, each agent and each node including a localized shared memory table (SMT) which logs known identifying information pertaining to other nodes on the network;
b. transmitting at least a first agent's SMT along the zero configuration network to a target node;
c. at the target node:
(i) detecting the first agent's SMT;
(ii) analyzing the identifying information within the first agent's SMT to ascertain existence of an IP address conflict involving the target node; and
d. resolving the IP address conflict upon satisfaction of selected conflict criteria.

2. A method according to claim 1 wherein said IP address conflict is resolved if it involves said first agent's node of origin.

3. A method according to claim 2 wherein said IP address conflict is resolved by one of said target node and said first agent's node of origin.

4. A method according to claim 3 whereby each SMT is organized as a plurality of record entries, each pertaining to a respective one of said nodes and each having an associated timestamp indicating when the record entry was logged at the associated agent.

5. A method according to claim 1 whereby each record entry includes an IP address and a unique identifier for the respective node.

6. A method according to claim 5 whereby each unique identifier is a Medium Access Control (MAC) address, and whereby said address conflict is resolved by the target node when the MAC address for the target node is less than the MAC address for the first agent's node of origin.

7. A method according to claim 1 whereby said target node resolves the IP address conflict by reconfiguring its IP address to select a new IP address.

8. A method according to claim 7 whereby the target node selects a new IP address which is currently unused in the target node's SMT.

9. A method according to claim 8 whereby the target node randomly selects said new IP address.

10. A method according to claim 8 comprising informing at least the origin node of said the new IP address.

11. A method according to claim 8 comprising logging the new IP address within the target node's SMT and thereafter transmitting the target node's SMT to at least the first agent's node of origin.

12. A method according to claim 1 whereby each of said nodes originally creates a plurality of like agents.

13. A system for resolving Internet Protocol (IP) address conflicts for a zero configuration network, comprising:
a. a plurality of agents each originating from a respective origin node that is characterized by an associated node address, each agent and each node including a localized shared memory table (SMT) which logs known identifying information pertaining to nodes on the network;
b. a transmission component associated with each node for selectively transmitting each agent's SMT to other remote nodes on the network; and
c. a detection component associated with each node for receiving each agent's SMT, said detection component:
(i) analyzing the identifying information in the received SMT at a local node to ascertain existence of an IP address conflict with any remote node on the network, and
(ii) resolving the address conflict upon determining that said conflict satisfies selected conflict criteria.

14. A system according to claim 13 wherein said detection component resolves the address conflict by selecting a new, unused IP address for its associated node.

15. A system according to claim 13 wherein each said localized SMT is organized as a plurality of record entries each pertaining to a respective origin node on the network and each having an associated timestamp indicating when the record entry was logged.

16. A system according to claim 15 wherein each record entry includes an IP address and a unique identifier for the agent's respective node.

17. A system according to claim 16 wherein one record entry within each agent's localized SMT pertains to the agent's node of origin, and each additional record entry pertains to a remote node.

18. A system according to claim 16 wherein said unique identifier is a Medium Access Control (MAC) address.

19. A system according to claim 16 wherein said each entry within the received SMT is compared to each entry within the local node's SMT to ascertain at least one of:
a. whether another node has reconfigured its IP address;
b. whether an IP address conflict exists with respect to any two nodes on the network; and
c. whether the respective entry within the received SMT is known to the local node.

20. A system according to claim 19 whereupon ascertaining that another node has reconfigured its IP address, the local node updates its SMT with the respective entry within the received SMT.

21. A system according to claim 19 whereupon ascertaining existence of an IP address conflict satisfying the conflict criteria, the local node reconfigures its IP address by selecting a new IP address which is not within its local SMT.

22. A system according to claim 19 whereupon ascertaining that the respective entry within the received SMT is unknown to the local node, the respective entry is added to the local node's SMT.

23. A system according to claim 19 whereupon ascertaining that the respective entry within the received SMT is known to the local node, the local node compares the timestamp associated with the entry in the received SMT to the timestamp associated with the corresponding entry in the local node's SMT and logs a more recent version thereof within the local node's SMT.

24. A system for resolving Internet Protocol (IP) address conflicts using agents for a zero configuration network, comprising:
a. an origin node creating at least a first agent having a shared memory table (SMT) which logs identifying information known by the first agent for other nodes on the network, said origin node for transmitting the first agent's SMT along the network; and
b. a target node for detecting the first agent's SMT and analyzing the identifying information logged therein to ascertain existence of a localized IP address conflict to be resolved between the target node and the origin node, whereupon said target node resolves said address conflict by selecting a new IP address for itself.

25. A system according to claim 24 wherein said target node logs a target node SMT which includes identifying information known by the target agent for other nodes on the network.

26. A system according to claim 24 wherein each SMT is organized as a plurality of record entries each associated with a respective node on the network and each having an associated timestamp indicating when the record entry was logged.

27. A system according to claim 26 wherein each record entry includes an IP address for the respective node and a unique identifier for the respective node.

28. A system according to claim 27 wherein each unique identifier is a Medium Access Control (MAC) address.

29. A system according to claim 28 wherein said target node is characterized by a target node IP address having an associated timestamp, and wherein said target node ascertains existence of an address conflict upon determining that said origin node has an identical IP address logged within the first agent SMT with a more recent associated timestamp.

30. A system according to claim 29 wherein existence of a localized IP address conflict to be resolved occurs when a comparison of the MAC address for the target node with the MAC address for the origin node satisfies a selected comparison criteria.

31. A system according to claim 30 wherein the selected comparison criteria is satisfied when the MAC address for the target node is less than the MAC address for the origin node.

32. A system according to claim 24 wherein said first agent SMT is organized as a plurality of record entries each associated with a respective node on the network which is known by the first agent, and wherein said target node logs an associated target node SMT which is organized as a plurality of record entries each associated with a respective agent on the network which is known by the target node.

33. A system according to claim 32 wherein one of the record entries within the first agent SMT pertains to said origin node, and wherein one of the record entries within the target SMT pertains to said target node.

34. A system according to claim 32 wherein each record entry within each SMT is characterized by an associated timestamp and includes an IP address field for the respective node and a Medium Access Control (MAC) address for the respective node.

35. A system according to claim 34 wherein said target node compares each entry within the first agent's SMT to each entry within the target node SMT to ascertain at least one of:
a. whether another node has reconfigured its IP address;
b. whether an IP address conflict exists with respect to any two nodes on the network; and
c. whether the respective entry within the first agent's SMT is known to the target node.

36. A system according to claim 35 whereupon ascertaining that another agent has reconfigured its IP address, the target node updates the target node's SMT with the respective entry within the first agent SMT.

37. A system according to claim 35 whereupon ascertaining existence of a localized IP address conflict to be resolved, the target node selects a currently unused IP address.

38. A system according to claim 35 whereupon ascertaining that the respective entry is unknown to the target node, the respective entry is added to the target node's SMT.

39. A system according to claim 35 whereupon ascertaining that the respective entry is known to the target node, the target node compares the timestamp associated with the entry in the first agent's SMT to the timestamp associated with the corresponding entry in the target node's SMT and logs a more recent version thereof within the target node's SMT.

40. A system according to claim 24 wherein the target node selects a new IP address which is not within the target node SMT.
